(19) United States
(12) Patent Application Publication
(10) Pub. No.: US 2010/0310206 A1
(43) Pub. Date: Dec. 9, 2010

(54) OPTICAL MODULATOR

(75) Inventors: Kenji Kawano, Atsugi-shi (JP); Seiji Uchida, Atsugi-shi (JP); Eiji Kawazura, Ebina-shi (JP); Yuji Sato, Atsugi-shi (JP); Masaya Nanami, Zama-shi (JP); Toru Nakahira, Atsugi-shi (JP); Nobuhiro Igarashi, Sagamihara-shi (JP); Satoshi Matsumoto, Tokyo (JP)

Correspondence Address: GREER, BURNS & CRAIN, 300 S WACKER DR, 25TH FLOOR, CHICAGO, IL, 60606, US

(73) Assignee: ANRITSU CORPORATION, Atsugi-shi (JP)

(21) Appl. No.: 12/863,126

(22) PCT Filed: Jan. 18, 2008
(86) PCT No.: PCT/JP2008/000048

§ 371 Date: Jul. 15, 2010

(51) Int. Cl. G02F 1/035

(52) U.S. Cl. 385/2

(57) ABSTRACT

A technical problem related to a traveling wave electrode type of optical modulator comprising a substrate having the electro-optical effect, optical waveguides formed in the substrate, and a traveling wave electrode formed above the substrate includes improvement of the characteristics such as optical modulation bandwidth, driving voltage, and characteristic impedance of the traveling wave electrode type of optical modulator. To solve the problem, the structure of ridge portions is optimized which is formed in such a manner that a part of the substrate at regions where electric field generated by a high frequency electric signal traveling through the traveling wave electrode is strong is reduced in thickness by digging. Further, a buffer layer is formed over the substrate where the ridge portions are formed and a conducting layer is formed over the buffer layer. The thickness of at least one part of the buffer layer along the normal line of a side surface of the ridge portions is less than the thickness of the buffer layer on a bottom surface between the ridge portions formed by digging and/or the thickness of the buffer layer on a top part of the ridge portions.

### TECHNICAL FIELD

The present invention relates to an optical modulator for modulating, with high frequency electric signal, an incident light in an optical waveguide to be outputted as an optical pulse signal.

### BACKGROUND ART

In recent years, there has been practically used an optical communication system with high speed and large capacity. Many requests have been made to develop an optical modulator with high volume, small size and low cost for the purpose of enabling the optical modulator to be embedded in the optical communication system with high speed and large capacity.

In response to these requests, there have so far been developed various types of optical modulators one of which is a traveling wave electrode type of lithium niobate optical modulator comprising a substrate made of a material such as lithium niobate (LiNbO₃) having an electro-optic effect (hereinafter simply referred to as an LN substrate), an optical waveguide formed in the LN substrate and a traveling wave electrode formed on the substrate. The lithium niobate optical modulator of this type will be simply referred to as an LN optical modulator hereinafter. The electro-optic effect is adapted to vary a refractive index of the LN substrate in response to an electric field applied to the LN substrate. This type of LN optical modulator has been applied to a large volume optical communication system having a capacity of 2.5 Gbit/s or 10 Gbit/s due to the excellent chirping characteristics. In recent years, the LN optical modulator thus constructed is under review to be applied to the optical communication system having a super large capacity of 40 Gbit/s.

Characteristics of the conventional LN optical modulators using the electro-optic effect of lithium niobate realized or proposed will be described in turn hereinafter.

### FIRST PRIOR ART

FIG. 15 is a perspective view showing an LN optical modulator constituted by a z-cut state LN substrate according to the first prior art disclosed in patent document 1. FIG. 16 is a cross-sectional view taken along the line A-A′ of FIG. 15.

The z-cut LN substrate 1 has an optical waveguide 3 formed therein. The optical waveguide 3 is formed with a process of thermally diffusing a metal Ti (titanium) at a temperature of 1050 degrees C. for approximately 10 hours, and the optical waveguide 3 forms a Mach-Zehnder interferometer (or a Mach-Zehnder optical waveguide). This results in the fact that the optical waveguide 3 is constituted by two interaction optical waveguides 3a and 3b at a portion (or an interaction portion) where the incident light is interacted with an electric signal. In other words, two arms of the Mach-Zehnder optical waveguide are formed at the interaction portion.

The optical modulator further comprises an SiO₂ buffer layer 2 formed on the optical waveguide 3, and a traveling wave electrode 4 formed above the SiO₂ buffer layer 2. The traveling wave electrode 4 is constituted by a coplanar waveguide (CPW) having a center electrode 4a and two ground electrodes 4b and 4c. The traveling wave electrode 4 is generally made by metal Au. The optical modulator has an Si conducting layer 5 formed over the SiO₂ buffer layer 2 for suppressing temperature drift caused by a pyroelectric effect. The pyroelectric effect is peculiar in the case that the z-cut LN substrate 1 is used to form the LN optical modulator. The Si conducting layer 5, which is shown in FIG. 15, is omitted in FIG. 16 to avoid the tedious explanation.

The optical modulator further comprises a feeder wire 6 for the high frequency (RF) electric signal. The high frequency (RF) electric signal for modulation is supplied to the center electrode 4a and the ground electrodes 4b, 4c through the feeder wire 6 for the high frequency (RF) electric signal, which results in an electric field applied between the center electrode 4a and the ground electrodes 4b, 4c. This electric field induces an effective refractive index n₀ of each of the interaction optical waveguides 3a and 3b to be varied, due to the electro-optic effect of the z-cut LN substrate 1. This results in the fact that incident lights respectively traveling through the interaction optical waveguides 3a and 3b have phases different from each other. The optical output is switched to “OFF” state when the phase difference becomes “π”, resulting from the fact that higher-order mode is excited at a merge portion of the Mach-Zehnder optical waveguide 3, where the interaction optical waveguides 3a and 3b are merged. The optical modulator further comprises an output wire 7 for the high frequency (RF) electric signal. The output wire 7 for the high frequency electric signal may be replaced by a termination resistance.

As can be seen from FIG. 16, the optical modulator disclosed in the patent document 1 has following characteristics.

1) The center electrode 4a has a width “S” in the range of approximately 6 to 12 μm, which is substantially equal to the widths of the interaction optical waveguides 3a and 3b.

2) The center electrode 4a and each of the ground electrodes 4b and 4c form a gap “W” such that the gap has a wide width in the range of approximately 15 to 30 μm.

3) Microwave equivalent refractive index nₘ, for the high frequency electric signal is reduced to be closer to the effective refractive index n₀ of each of the interaction optical waveguides 3a and 3b, while shifting a characteristic impedance of the high frequency electric signal to be closer to 50Ω, by setting a thickness “D” of the SiO₂ buffer layer 2 as thick as approximately 400 nm to 1.5 μm by utilizing the fact that the SiO₂ buffer layer 2 has a relative permittivity which is relatively as low as 4 to 6. The SiO₂ buffer layer 2 has previously been utilized only for suppressing absorption of the incident lights traveling through the interaction optical waveguides 3a and 3b caused by the metal of the center electrode 4a and ground electrodes 4b and 4c. In the patent document 2, the optical modulator has a similar constitution with the optical modulator disclosed in the patent document 1 shown in FIG. 16, while having a thickness “T” larger than that of the patent document 2, to ensure that the microwave equivalent refractive index nₘ, is further reduced to be closer to the effective refractive index n₀ of each of the interaction optical waveguides 3a and 3b.

The optical modulator with the above mentioned construction has improved characteristics, such as for example, optical modulation bandwidth and characteristic impedance in comparison with the characteristics of the conventional optical modulator with the center electrode 4a having a width S of approximately 30 μm, gaps W between the center electrode 4a and the ground electrodes 4b and 4c, of approximately 6 μm, and the SiO₂ buffer layer 2 having a thickness D of 300 nm. However, more improved characteristics in optical modulation bandwidth, driving voltage, and characteristic impedance have been requested for the optical modulator. In response to this request, there has been proposed an optical modulator having a construction of so-called “ridge structure”. The optical modulator with the ridge structure will be described hereinafter as a second prior art.

### SECOND PRIOR ART

FIG. 17 shows the so-called ridge structure as the second prior art disclosed in the patent document 3, which has been proposed to further enhance the performance of the optical modulator compared to that of the first prior art. FIG. 18 shows an enlarged view of the area represented by “B” in FIG. 17. As shown in FIG. 18, the optical modulator comprises a ridge portion 8a below the center electrode 4a, a ridge portion 8b below the ground electrode 4b, and a ridge portion 8c below the ground electrode 4c. The z-cut LN substrate 1 has a bottom surface 9a between the ridge portions 8a and 8c, a bottom surface 9b between the ridge portions 8a and 8b. The ridge portions 8a to 8c have top parts 10a to 10c, respectively. The ridge portions 8a and 8b collectively form a gap portion 11b, while the ridge portions 8a and 8c collectively form a gap portion 11a.

The legend “H” represents a height of the ridge portions 8a to 8c. The legend “T” represents a thickness of the traveling wave electrode 4. The legend “D” represents a thickness of the SiO₂ buffer layer 2 on the bottom surface 9a between the ridge portions 8a and 8c, and on the top part 10a of the ridge portion 8a. The normal line of the side surface of the ridge portion 8a positioned under the center electrode 4a is represented by a reference numeral “12”. The thickness of the SiO₂ buffer layer 2 along the normal line 12 is assumed to be equal to D. Electric lines of force 13 extending from the center electrode 4a to the ground electrodes 4b and 4c are also shown in FIG. 19. The electric lines of force 13 affect the interaction optical waveguides 3a and 3b in that the refractive index of each of the interaction optical waveguides 3a and 3b is varied. In other words, the electric lines of force 13 interact with the incident lights traveling through the respective interaction optical waveguides 3a and 3b.

The optical modulator according to the second prior art is advantageous in that the microwave equivalent refractive index nₘ can be reduced more to be closer to the effective refractive index n₀ of each of the interaction optical waveguides 3a and 3b, and in that the characteristic impedance of the high frequency electric signal can be higher to be closer to 50Ω. This results from the fact that the ridge portions 8a and 8b are formed on the z-cut LN substrate 1, and that the electric lines of force 13 can pass through the gap portion 11b formed between the ridge portions 8a and 8b, and the gap portion 11a formed between the ridge portions 8a and 8c. In addition, the electric lines of force 13 have a characteristic to be confined in a region having a high relative permittivity. Therefore, the electric lines of force 13 can have high interaction efficiency with the incident lights passing through the interaction optical waveguides 3a and 3b, which results in the reduction in driving voltage. Generally, the ridge portions 8a, 8b and 8c each have a height H in the range of approximately 2 to 5 μm. The traveling wave electrode 4 has a thickness T in the range of approximately 6 to 18 μm, and the SiO₂ buffer layer 2 has a thickness in the range of approximately 400 nm to 1.5

The optical modulator according to the second prior art has a fundamental performance of the optical modulator highly improved compared to the optical modulator according to the first prior art shown in FIG. 16, where the fundamental performance is exemplified by an optical modulation bandwidth, driving voltage, and a characteristic impedance.

The optical modulator according to the second prior art, however, still encounters a problem to be solved. That is to say, a relative permittivity of the SiO₂ buffer layer 2 is 4 to 6, which is less than a relative permittivity of 34 on average of the z-cut LN substrate 1 (since the z-cut LN substrate has anisotropy between a direction perpendicular to the surface of the z-cut LN substrate 1 and a direction parallel to a longitudinal direction of the optical waveguide 3), and is larger than a relative permittivity of air, where air has a relative permittivity of 1.

In the second prior art, if the thickness of the SiO₂ buffer layer along the normal line of the side surface of the ridge portions 8a to 8c (or on the ridge portions 8a to 8c) shown in FIG. 17 is equal to the thickness of the SiO₂ buffer layer 2 on the bottom surfaces 9a, 9b between the ridge portions and the top parts 10a to 10c of the ridge portions, comparatively large number of the electric lines of force 13 are confined in the SiO₂ buffer layer 2 deposited on the side surface of the ridge portions 8a to 8c, in addition to the gap portion 11b formed between the ridge portions 8a and 8b, and the gap portion 11a formed between the ridge portions 8a and 8c, as seen from FIG. 19.

As shown in FIG. 19, the side surface of the ridge portions 8a to 8c is generally inclined to the top parts 10a to 10c of the ridge portions in the process of forming the ridge portions (i.e. the ridge portions 8a to 8c are trapezoid in shape). The direction of the inclination is the same direction along the electric lines of force diverging from the center electrode 4a to the ground electrodes 4b, 4c (see, for example, the lower side of the electric lines of force 13 shown in FIG. 19). This results in the fact that characteristics of the LN optical modulator, such as for example, microwave equivalent refractive index nₘ, characteristic impedance, and driving voltage are highly dependent on the thickness of the SiO₂ buffer layer 2 deposited on the side surface of the ridge portions 8a to 8c.

In other words, the advantageous effect of the ridge structure to reduce the microwave equivalent refractive index nₘ, to be closer to the effective refractive index n₀ of each of the interaction optical waveguides 3a and 3b, and to raise the characteristic impedance of the high frequency electric signal to be closer to 50Ω, can not be maximally realized in the second prior art. Hereinafter, for simplicity, the thickness of the SiO₂ buffer layer on the side surface of the ridge portions 8a to 8c is assumed to be equal to the thickness of the SiO₂ buffer layer 2 on the bottom surfaces 9a, 9b between the ridge portions and on the top parts 10a to 10c of the ridge portions.

Although there has been described about the thickness of the SiO₂ buffer layer 2 and not described about the Si conducting layer 5 for simplicity in the second embodiment, the Si conducting layer 5 formed over the SiO₂ buffer layer 2, as shown in FIG. 15 of the first prior art, is essential to suppress the temperature drift in the LN optical modulator using the z-cut LN substrate 1. As mentioned above, however, a relative permittivity of the Si conducting layer is about 11 to 13, which is much larger than a relative permittivity of about 4 to 6 of the SiO₂ buffer layer 2. Therefore, the problem attributed to the thickness of the SiO₂ buffer layer 2 on the side surface of the ridge portions, which has been described in detail in the second embodiment, is true of the Si conducting layer. This fact will be described in the embodiments of this invention.

### (Patent Document 1)

Japanese Patent Laying-Open Publication No. H02-51123

### (Patent Document 2)

Japanese Patent Laying-Open Publication No. H01-91111

### (Patent Document 3)

Japanese Patent Laying-Open Publication No. H04-288518

As described above, the LN optical modulator according to the second prior art can improve the optical modulation characteristics such as optical modulation bandwidth, driving voltage, and characteristic impedance, compared to the optical modulator according to the first prior art. However, if the thickness of the SiO₂ buffer layer on the side surface of the ridge portions is nearly equal to the thickness of the SiO₂ buffer layer on the bottom surface between the ridge portions or the top part of the ridge portions, large number of the electric lines of force generated by the high frequency electric signal traveling through the traveling wave electrode are confined in the SiO₂ buffer layer, or the length of the electric lines of force is relatively long. This results in the fact that the gap portions are not effectively used. Therefore, there exists the problem that the microwave equivalent refractive index is not sufficiently reduced to be closer to the effective refractive index of the optical waveguide (that is, the reduction in the microwave equivalent refractive index is insufficient to perform the optical modulation over a wide range of frequencies), and that there is still room for improvement in reducing the driving voltage and heightening the characteristic impedance. The same problem also exists in the Si conducting layer for suppressing the temperature drift. A more detailed discussion of this problem will be described hereinafter. The prior art has ignored the fact that the SiO₂ buffer layer (or the Si conducting layer) above the side surface of the ridge portions seriously affect the optical modulation characteristics. Therefore, the above mentioned problem arises in the optical modulation characteristics in the case where the thickness of the SiO₂ buffer layer (or the Si conducting layer) above the side surface is large. While in the case where the SiO₂ buffer layer (or the Si conducting layer) is not formed above the side surface, the optical modulation characteristics is deteriorated. Furthermore, assuming that the SiO₂ buffer layer is not formed on the side surface, and that the Si conducting layer is directly deposited onto the side surface of the ridge portions, the Si conducting layer absorbs the incident lights respectively traveling through the interaction optical waveguides formed in the ridge portions, resulting in an increase in insertion loss. In this case, the distribution of electrical charges generated by the pyroelectric effect becomes nonuniform, resulting in the temperature drift. Needless to say, if the Si conducting layer does not exist in the optical modulator, extreme temperature drift which is unacceptable for practical use occurs.

### SUMMARY OF INVENTION

It is, therefore, an object of the present invention to provide an optical modulator to solve the problems in accordance with the examples of the prior art, which can have a wide optical modulation bandwidth, low driving voltage, reduced jitter in optical pulses, proper characteristic impedance, excellent insertion loss, and significantly reduced temperature drift.

According to a first aspect of the present invention, there is provided an optical modulator, comprising: a substrate having an electro-optic effect; a buffer layer formed over said substrate; a conducting layer formed over said buffer layer; and a traveling wave electrode including a center electrode and a ground electrode formed on at least a part of said conducting layer, in which said substrate has a plurality of ridge portions which are formed by digging said substrate at regions where electric field generated by a high frequency electric signal traveling through said traveling wave electrode is strong, and at least one of said ridge portions has an optical waveguide formed therein, characterized in that said buffer layer is formed on a top part and a side surface of said ridge portions, and on a bottom surface between said ridge portions formed by said digging, and a thickness of said buffer layer along a normal line of said side surface of said ridge portions is less than a thickness of said buffer layer on said bottom surface between said ridge portions and/or a thickness of said buffer layer on said top part of said ridge portions, to ensure that a microwave equivalent refractive index for said high frequency electric signal is reduced to be closer to an effective refractive index of said optical waveguide, as compared to the case where a thickness of said buffer layer along a normal line of said side surface of said ridge portions is equal to a larger one of a thickness of said buffer layer on said top part of said ridge portions and a thickness of said buffer layer on said bottom surface between said ridge portions.

According to a second aspect of the present invention, there is provided an optical modulator, in which said side surface of said ridge portions is inclined.

According to a third aspect of the present invention, there is provided an optical modulator, in which a thickness of said buffer layer along a normal line of said side surface of said ridge portions is less than ¾ of a thickness of said buffer layer on said bottom surface between said ridge portions formed by said digging and/or a thickness of said buffer layer on said top part of said ridge portions.

According to a fourth aspect of the present invention, there is provided an optical modulator, in which a thickness of said buffer layer along a normal line of said side surface of said ridge portions is less than ⅔ of a thickness of said buffer layer on said bottom surface between said ridge portions formed by said digging and/or a thickness of said buffer layer on said top part of said ridge portions.

According to a fifth aspect of the present invention, there is provided an optical modulator, in which a thickness of said buffer layer along a normal line of said side surface of said ridge portions is less than ½ of a thickness of said buffer layer on said bottom surface between said ridge portions formed by said digging and/or a thickness of said buffer layer on said top part of said ridge portions.

According to a sixth aspect of the present invention, there is provided an optical modulator, further comprising another conducting layer formed above said top part and said side surface of said ridge portions, and above said bottom surface between said ridge portions formed by said digging, in which a thickness of said another conducting layer along a normal line of said side surface of said ridge portions is less than a thickness of said buffer layer on said bottom surface between said ridge portions and/or a thickness of said another conducting layer above said top part of said ridge portions, to ensure that a microwave equivalent refractive index for said high frequency electric signal is reduced to be closer to an effective refractive index of said optical waveguide, as compared to the case where a thickness of said another conducting layer along a normal line of said side surface of said ridge portions is equal to a larger one of a thickness of said another conducting layer above said top part of said ridge portions and a thickness of said another conducting layer above said bottom surface between said ridge portions.

According to a seventh aspect of the present invention, there is provided an optical modulator, in which a thickness of said another conducting layer along a normal line of said side surface of said ridge portions is less than ¾ of a thickness of said another conducting layer above said bottom surface between said ridge portions formed by said digging and/or a thickness of said another conducting layer above said top part of said ridge portions.

According to a eighth aspect of the present invention, there is provided an optical modulator, in which a thickness of said another conducting layer along a normal line of said side surface of said ridge portions is less than ⅔ of a thickness of said another conducting layer above said bottom surface between said ridge portions formed by said digging and/or a thickness of said another conducting layer above said top part of said ridge portions.

According to a ninth aspect of the present invention, there is provided an optical modulator, in which a thickness of said another conducting layer along a normal line of said side surface of said ridge portions is less than ½ of a thickness of said another conducting layer above said bottom surface between said ridge portions formed by said digging and/or a thickness of said another conducting layer above said top part of said ridge portions.

According to a tenth aspect of the present invention, there is provided an optical modulator, in which a width of said top part of one of said ridge portions which has said optical waveguide formed therein and around which said center electrode of said traveling wave electrode is formed is substantially equal to a width of said center electrode.

According to a eleventh aspect of the present invention, there is provided an optical modulator, in which a width of said top part of one of said ridge portions which has said optical waveguide formed therein and around which said center electrode of said traveling wave electrode is formed is wider than a width of said center electrode.

According to a twelfth aspect of the present invention, there is provided an optical modulator, in which a width of said top part of one of said ridge portions which has said optical waveguide formed therein and around which said center electrode of said traveling wave electrode is formed is narrower than a width of said center electrode.

According to a thirteenth aspect of the present invention, there is provided an optical modulator, in which a ratio of said width of said center electrode divided by said width of said top part of one of said ridge portions is in the range of ⅕ to 1.

According to a fourteenth aspect of the present invention, there is provided an optical modulator, in which a ratio of said width of said center electrode divided by said width of said top part of one of said ridge portions is in the range of 1 to 5.

According to a fifteenth aspect of the present invention, there is provided an optical modulator, in which said optical waveguide formed in at least one of said ridge portions is positioned light below said center electrode of said traveling wave electrode, with said buffer layer intervening between said optical waveguide and said traveling wave electrode.

The optical modulator according to this invention can reduce the number of the electric lines of force confined in the SiO₂ buffer layer or the Si conducting layer on the side surface of the ridge portions, which is generated by the high frequency electric signal traveling through said traveling wave electrode, or can reduce the length of the electric lines of force passing through the SiO₂ buffer layer or the Si conducting layer. This results from the fact that the thickness of the SiO₂ buffer layer or the Si conducting layer formed above the side surface of the ridge portions is less than the thickness of the SiO₂ buffer layer (or the Si conducting layer) formed above the bottom surface between the ridge portions and/or the thickness of the SiO₂ buffer layer (or the Si conducting layer) formed above the top part of the ridge portions. Accordingly, the electric lines of force are effectively distributed in the gap portions collectively formed by the ridge portions and in the ridge portions of the z-cut LN substrate, thereby enabling the optical modulator according to this invention to improve the optical modulation characteristics. That is to say, the microwave equivalent refractive index nₘ, can effectively be shifted closer to the effective refractive index n₀ of the interaction optical waveguides (or nₘ=n₀, that is, velocity matching is satisfied), the optical modulation over a wide range of frequencies can be realized, the driving voltage can be reduced, and the characteristic impedance can be heightened. The construction disclosed in this application is aimed to optimize (or improve) the characteristics of the LN optical modulator such as optical modulation bandwidth and driving voltage, by making the thickness of the SiO₂ buffer layer or the Si conducting layer on the side surface of the ridge portions less than the thickness of the SiO₂ buffer layer or the Si conducting layer on the top part of the ridge portions and on the bottom surface between the ridge portions, and by optimizing the structure of the LN optical modulator, in response to construction parameters such as thickness and width of the traveling wave electrode (in particular thickness and width of the center electrode), depth between the top part and the bottom surface of the ridge portions, width of the top part of the ridge portions (in particular width of the top part above which the center electrode is formed), gap between the center electrode and the ground electrodes, and inclination of the ridge portions. In other words, the optical modulator according to this invention is aimed to not only decrease the thickness of the SiO₂ buffer layer or the Si conducting layer deposited on the side surface of the ridge portions, but to optimize the structure of the LN optical modulator. That is to say, the present invention is aimed to maximally realize the advantageous effect of the LN optical modulator by decreasing the thickness of the SiO₂ buffer layer or the Si conducting layer deposited on the side surface of the ridge portions, and by optimizing the structure so as to optimize (or improve) the optical modulation characteristics such as optical modulation bandwidth, driving voltage, jitter in optical pulses, and characteristic impedance, taking into consideration that the electric lines of force pass through the SiO₂ buffer layer and the Si conducting layer, in response to the above mentioned construction parameters such as thickness of the traveling wave electrode, except thickness of the SiO₂ buffer layer or the Si conducting layer deposited on the side surface of the ridge portions. In the present invention, the Si conducting layer for suppressing the temperature drift does not absorb the incident lights respectively traveling through the interaction optical waveguides. Since the Si conducting layer is formed after the deposition of the SiO₂ buffer layer onto the side surface of the ridge portions in the present invention, the distribution of electrical charges generated by the pyroelectric effect is uniform even if the environment temperature changes, thereby resulting in suppression of the temperature drift. Thus, the optical modulator according to this invention is able to suppress the temperature drift without increasing the insertion loss.

### BRIEF DESCRIPTION OF DRAWINGS

FIG. 1 is a sectional view schematically showing the optical modulator according to the first embodiment of the present invention;

FIG. 2 is an enlarged view of the area C in FIG. 1;

FIG. 3 is a graph to explain an operating principle of the optical modulator according to the first embodiment of the present invention;

FIG. 4 is a graph to explain an operating principle of the optical modulator according to the first embodiment of the present invention;

FIG. 5 is a graph to explain an operating principle of the optical modulator according to the first embodiment of the present invention;

FIG. 6 is a graph to explain an operating principle of the optical modulator according to the first embodiment of the present invention;

FIG. 7 is a graph to explain an operating principle of the optical modulator according to the first embodiment of the present invention;

FIG. 8 is a sectional view schematically showing the optical modulator according to the second embodiment of the present invention;

FIG. 9 is an enlarged view of the area E in FIG. 8;

FIG. 10 is a sectional view schematically showing the optical modulator according to the third embodiment of the present invention;

FIG. 11 is an enlarged view of the area F in FIG. 10;

FIG. 12 is a sectional view schematically showing the optical modulator according to the fourth embodiment of the present invention;

FIG. 13 is a sectional view schematically showing the optical modulator according to the fifth embodiment of the present invention;

FIG. 14 is a sectional view schematically showing the optical modulator according to the sixth embodiment of the present invention;

FIG. 15 is a perspective view showing the optical modulator according to the first prior art;

FIG. 16 is a sectional view taken along the line A-A′ of FIG. 15 showing the optical modulator;

FIG. 17 is a sectional view schematically showing the optical modulator according to the second prior art; and

FIG. 18 is an enlarged view of the area B in FIG. 17;

FIG. 19 is a graph to explain problems on the optical modulator according to the second prior art.

1: z-cut LN substrate
2: SiO₂ buffer layer
3: Mach-Zehnder optical waveguide
3a, 3b: interaction optical waveguide
4: traveling wave electrode
4a: center electrode
4b, 4c: ground electrodes
5: Si conducting layer
6: feeder wire
7: output wire
8a: ridge portion positioned under the center electrode 4a
8b: ridge portion positioned under the ground electrode 4b
8c: ridge portion positioned under the ground electrode 4c
9a, 9b: bottom surface between the ridge portions
10a, 10b, 10c: top part of the ridge portions
11a, 11b: gap portion collectively formed by the ridge portions
12: normal line of a side surface of the ridge portions
13, 30: electric line of force
16: Si conducting layer
20: edge at the lower side of the center electrode 4a
21: edge at the top part of the ridge portion 8a
40: edge at the lower side of the ground electrode 4b
41: edge at the top part of the ridge portion 8b

### DESCRIPTION OF EMBODIMENTS

The embodiments of this invention will now be described hereinafter. The constitutional elements having the reference numerals same with the prior art will be omitted due to the fact that the constitutional elements have the same function with those of the prior art.

### First Embodiment

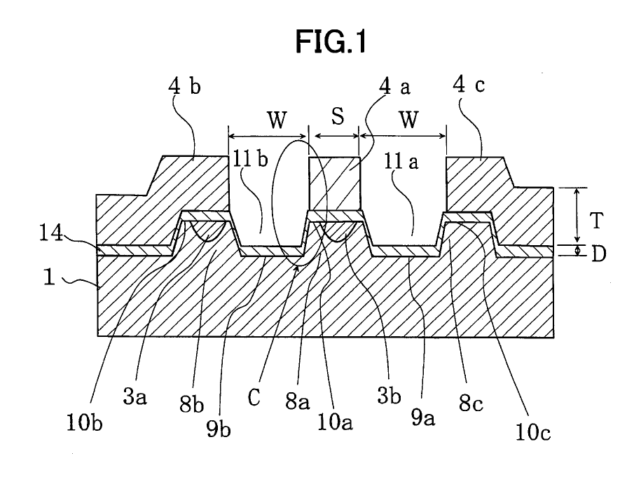

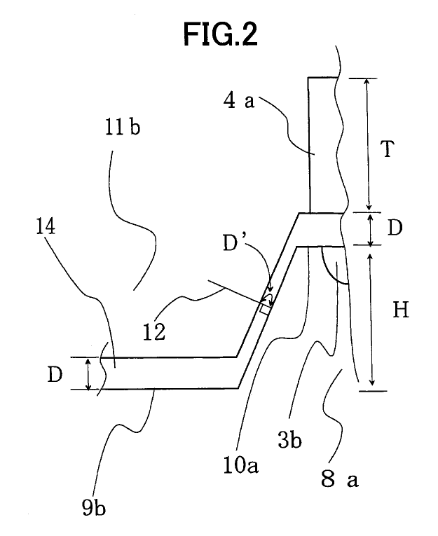

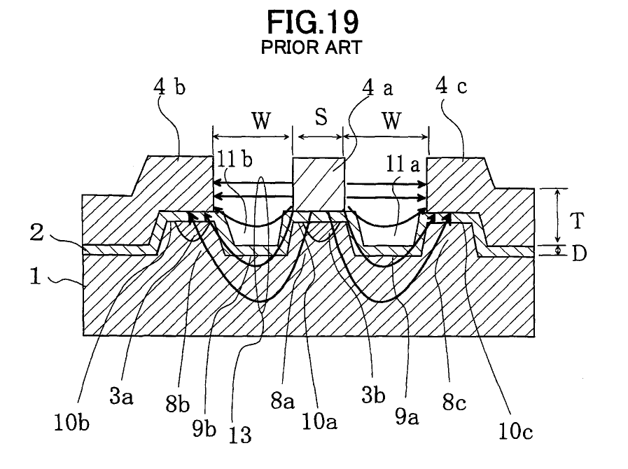

The optical modulator according to the first embodiment of the present invention has an SiO₂ buffer layer 14. FIG. 1 is a sectional view schematically showing the optical modulator which is manufactured by controlling the deposition of the SiO₂ buffer layer 14. FIG. 2 is an enlarged view of the area C in FIG. 1. In this embodiment, as can be seen from FIG. 1 or FIG. 2, the thickness D′ of the SiO₂ buffer layer 14 on the side surface of the ridge portion 8a is less than the thickness D of the SiO₂ buffer layer 14 on the bottom surfaces 9a, 9b between the ridge portions or on the top parts 10a to 10c of the ridge portions. As in the case of FIG. 19, the Si conducting layer for suppressing the temperature drift is omitted in the first embodiment and in the second embodiment to avoid the tedious explanation.

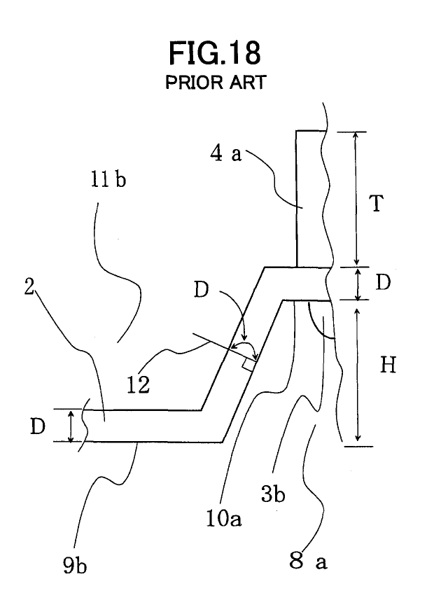

Although the thickness of the SiO₂ buffer layer 14 on the bottom surfaces 9a, 9b between the ridge portions and the thickness of the SiO₂ buffer layer 14 on the top parts 10a to 10c of the ridge portions may be different from each other, these thicknesses are assumed to be equal to the thickness D which is the same as the second prior art shown in FIG. 18 hereinafter for simplicity. Furthermore, for simplicity, the thickness of the SiO₂ buffer layer 14 on the side surface of the ridge portions 8a to 8c is hereinafter represented by the thickness of the SiO₂ buffer layer 14 on the side surface of the ridge portion 8a. In addition, these simplifications can be applied to all embodiments of this invention.

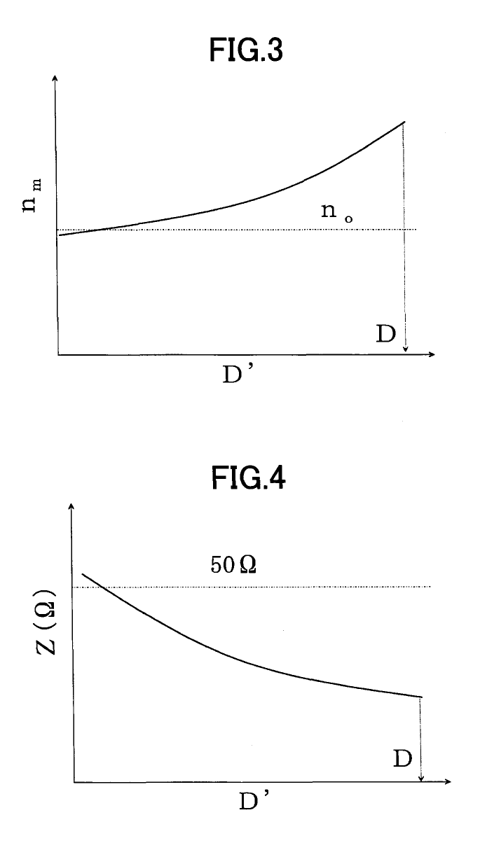

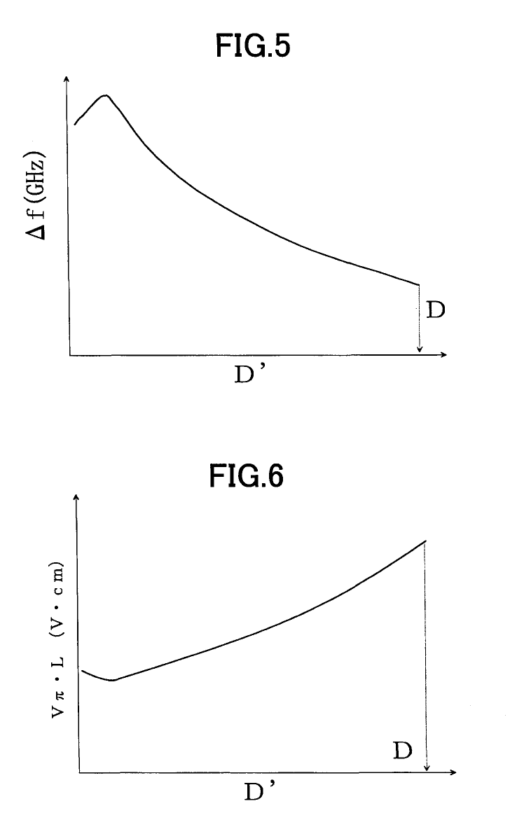

FIG. 3 is a graph showing the microwave equivalent refractive index nₘ, for the high frequency electric signal in response to the thickness D′ of the SiO₂ buffer layer 14 on the side surface of the ridge portion 8a. FIG. 4 is a graph showing the characteristic impedance Z of the optical modulator in response to the thickness D′. FIG. 5 is a graph showing 3 dB bandwidth Δf in response to the thickness D′. FIG. 6 is a graph showing a product Vπ*L of a half-wave voltage Vπ and a length L of the interaction optical waveguide in response to the thickness D′. As can be seen from these figures, the microwave equivalent refractive index nₘ, for the high frequency electric signal, the characteristic impedance Z of the optical modulator, the 3 dB bandwidth Δf and the product Vπ*L indicating the magnitude of the driving voltage are highly dependent on the thickness D′ of the SiO₂ buffer layer 14 on the side surface of the ridge portion 8a. It is also found that the thickness D′ has an optimum value.

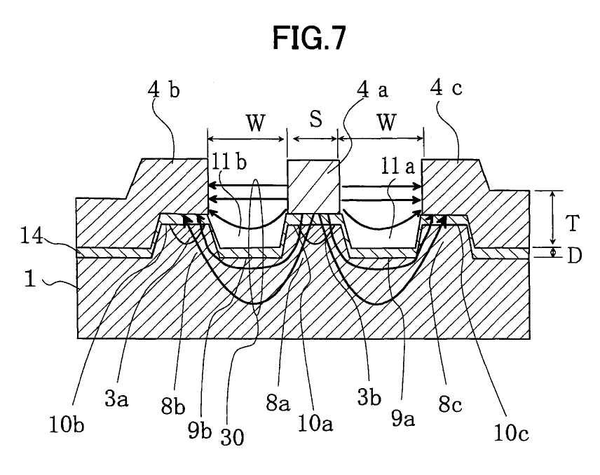

That is to say, as the thickness D′ of the SiO₂ buffer layer 14 on the side surface of the ridge portion 8a (and 8b, 8c) decreases, the electric lines of force generated by the high frequency electric signal are distributed in the gap portion 11a (and 11b) collectively formed by the ridge portions and in the ridge portion 8a (and 8b, 8c). This results from the fact that the electric lines of force cannot easily pass through the SiO₂ buffer layer on the side surface of the ridge portion 8a (and 8b, 8c), or the length of the electric lines of force is relatively short even if the electric lines of force can pass through the SiO₂ buffer layer 14. This results in the fact that the microwave equivalent refractive index nₘ for the high frequency electric signal can be efficiently reduced, and that the electric lines of force can effectively interact with the interaction optical waveguides 3a and 3b. FIG. 7 is a graph schematically showing this behavior. In FIG. 7, the legend “30” represents electric lines of force generated by the high frequency electric signal.

According to this first embodiment, the width S of the center electrode 4a is set at 9 μm, the gap W between the center electrode 4a and each of the ground electrodes 4b and 4c is set at 30 μm, the thickness T of the center electrode 4a and ground electrodes 4b and 4c is set at 26 μm, the height H of the ridge portions is set at 5 μm, and the thickness D of the SiO₂ buffer layer 14 on the bottom surfaces 9a and 9b between the ridge portions and at the top parts 10a to 10c of the respective ridge portions 8a to 8c is set at 1.5 μm. In this case, the thickness D′ of the SiO₂ buffer layer 14 on the side surface of the ridge portion 8a has an optimum value which is about 0.16 μm.

It goes without saying that the optimum value of the thickness D′ of the SiO₂ buffer layer 14 on the side surface of the ridge portion 8a is dependent on the width S of the center electrode 4a, the gap W, the thickness T of the traveling wave electrode, the height H of the ridge portions, and the thickness D of the SiO₂ buffer layer 14 on the bottom surfaces 9a and 9b between the ridge portions and at the top parts 10a to 10c of the ridge portions. In addition, the principle of this invention can be applied to the optical modulator with dimensions different from the above described dimensions. More specifically, it is found that the advantageous effect of the present invention is obvious if the thickness D′ of the SiO₂ buffer layer 14 on the side surface of the ridge portion 8a is equal to or less than ¾ of the thickness D of the SiO₂ buffer layer 14 on the bottom surfaces 9a and 9b between the ridge portions and at the top parts 10a to 10c of the ridge portions, and that the effect is more obvious if the thickness D′ is equal to or less than ⅔ of the thickness D, and that the effect is extremely obvious if the thickness D′ is equal to or less than ½ of the thickness D.

As described above, the construction disclosed in this application is aimed to optimize (or improve) the characteristics of the optical modulator, such as for example, optical modulation bandwidth, driving voltage, jitter in optical pulses, and characteristic impedance, by making the thickness of the SiO₂ buffer layer 14 on the side surface of the ridge portions 8a to 8c less than the thickness of the SiO₂ buffer layer 14 on the top parts 10a to 10c of the ridge portions and at the bottom surfaces 9a and 9b between the ridge portions, and by optimizing the structure of the LN optical modulator, in response to construction parameters such as thickness and width of the traveling wave electrode (in particular thickness and width of the center electrode 4a), depth between the top part and the bottom surface of the ridge portions 8a to 8c (that is, the height H of the ridge portions shown in FIG. 2), width of the top parts 10a to 10c of the ridge portions (in particular, the width of the top part 10a above which the center electrode 4a is formed), gap between the center electrode 4a and the ground electrodes 4b, 4c, and inclination of the ridge portions.

In other words, in all embodiments, the present invention not only makes the thickness of the SiO₂ buffer layer 14 deposited on the side surface of the ridge portions 8a to 8c less than the thickness of the SiO₂ buffer layer 14 at the top parts 10a to 10c of the ridge portions and at the bottom surfaces 9a and 9b between the ridge portions, but optimizes the structure of the LN optical modulator. That is to say, the present invention is aimed to maximally realize the advantageous effect of the LN optical modulator, by decreasing the thickness of the SiO₂ buffer layer 14 deposited on the side surface of the ridge portions 8a to 8c, in response to the above mentioned construction parameters, such as thickness of the traveling wave electrode, other than thickness of the SiO₂ buffer layer 14 deposited on the side surface of the ridge portions 8a to 8c.

Needless to say, although the advantageous effect of the present invention is also realized in the case where the side surface of the ridge portions 8a to 8c are normal to the top parts 10a to 10c of the ridge portions, the effect becomes more obvious in the case where the side surface of the ridge portions 8a to 8c are inclined. This results from the fact that the side surface of the ridge portions 8a to 8c is generally inclined to the top parts 10a to 10c of the ridge portions in the process of forming the ridge portions (i.e. the ridge portions 8a to 8c are trapezoid in shape.) as shown in FIG. 2. The direction of the inclination is the same direction along the electric lines of force diverging from the center electrode 4a to the ground electrodes 4b, 4c (see, for example, the lower side of the electric lines of force 30 shown in FIG. 7). Accordingly, the electric lines of force 30 can easily pass through the SiO₂ buffer layer 14 deposited on the side surface of the ridge portions 8a to 8c. As a result, characteristics of the LN optical modulator, such as for example, microwave equivalent refractive index nₘ, optical modulation bandwidth, characteristic impedance, and driving voltage are, therefore, highly dependent on the thickness of the SiO₂ buffer layer 14 deposited on the side surface of the ridge portions 8a to 8c. The present invention can further improve the characteristics of the optical modulator by decreasing the thickness of the SiO₂ buffer layer 14 deposited on the side surface of the ridge portions 8a to 8c.

It is possible to make the thickness of the SiO₂ buffer layer 14 on the side surface of the ridge portions 8a to 8c less than the thickness of the SiO₂ buffer layer 14 on the bottom surfaces 9a, 9b between the ridge portions and at the top parts 10a to 10c of the ridge portions by optimizing the deposition of the SiO₂ buffer layer 14, or by etching part or whole of the SiO₂ buffer layer.

Here, the definition of the word “ridge portion” according to this invention is wide enough to be applied to any constructions in which the z-cut LN substrate 1 is not dug at portions below one or both of the ground electrodes 4b and 4c. Any of these constructions can have an effect of this invention, according to not only the first embodiment but also all embodiments of this invention. In this case, for example, the z-cut LN substrate is dug only above the bottom surface 9a or 9b between the ridge portions shown in FIG. 7.

### Second Embodiment

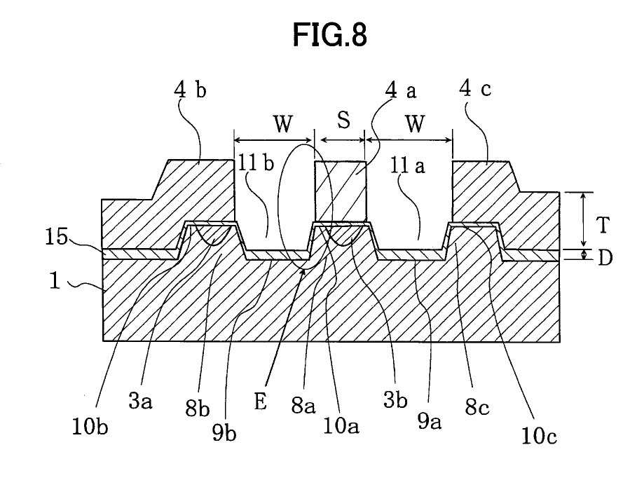

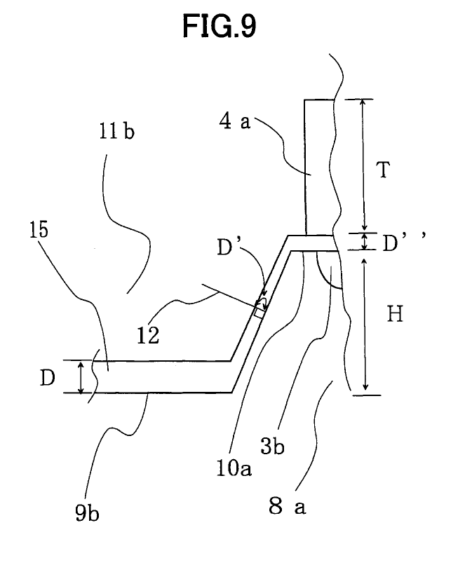

The optical modulator according to the second embodiment of the present invention has an SiO₂ buffer layer 15. FIG. 8 is a sectional view schematically showing the optical modulator which is manufactured by controlling the deposition of the SiO₂ buffer layer 15. FIG. 9 is an enlarged view of the area E in FIG. 8. The thickness of the SiO₂ buffer layer 15 on the bottom surface 9a between the ridge portions 8a and 8c (and on the bottom surface 9b between the ridge portions 8a and 8b) is different from the thickness of the SiO₂ buffer layer 15 on the top part 10a (and 10b, 10c) of the ridge portions. The thickness of the SiO₂ buffer layer on the side surface of the ridge portion 8a (and 8b and 8c) is less than a larger one of the thickness of the SiO₂ buffer layer 15 on the bottom surface 9a between the ridge portions 8a and 8c (and on the bottom surface 9b between the ridge portions 8a and 8b) and the thickness of the SiO₂ buffer layer 15 on the top part 10a (and 10b, 10c) of the ridge portions.

In the second embodiment, as can be seen from FIG. 8 or FIG. 9, the thickness D of the SiO₂ buffer layer 15 on the bottom surfaces 9a, 9b between the ridge portions is larger than the thickness D″ of the SiO₂ buffer layer 15 on the top parts 10a to 10c of the ridge portions. That is to say, D is larger than D″ (D>D″) as shown in FIG. 9. It is also possible that D is less than D″ (D<D″) as long as D′ is less than D″ (D′<D″).

That is to say, it is within the scope of this invention that the thickness of the SiO₂ buffer layer 15 on the side surface of the ridge portion 8a (and 8b and 8c) is less than a larger one of the thickness of the SiO₂ buffer layer on the bottom surface 9a between the ridge portions 8a and 8c (and on the bottom surface 9b between the ridge portions 8a and 8b) and the thickness of the SiO₂ buffer layer on the top part 10a (and 10b, 10c) of the ridge portions.

### Third Embodiment

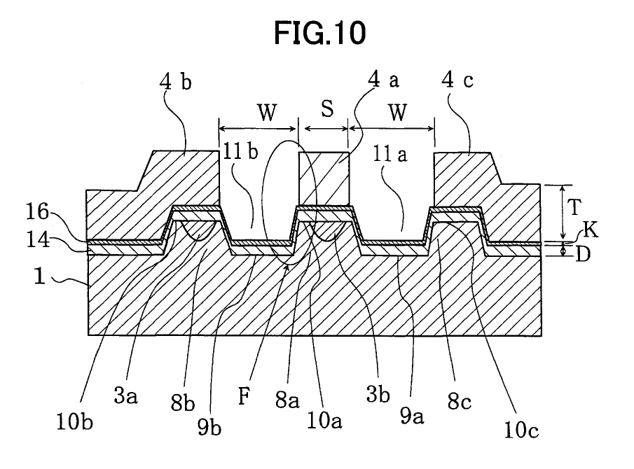

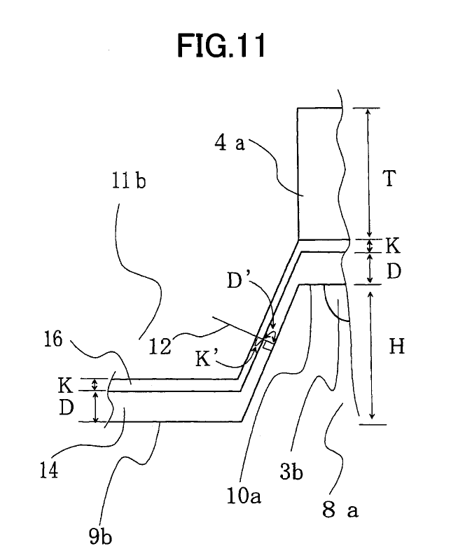

The optical modulator according to the third embodiment of the present invention has an Si conducting layer 16 for suppressing the temperature drift. FIG. 10 is a sectional view schematically showing the optical modulator which is manufactured by controlling the deposition of the SiO₂ buffer layer 14 and the Si conducting layer 16. FIG. 11 is an enlarged view of the area F shown in FIG. 10. These figures are to more fully explain the first embodiment of the present invention shown in FIGS. 1 and 2, where the explanation of the Si conducting layer 16 for suppressing the temperature drift is not omitted, although the Si conducting layer 16 is omitted only for simplicity in FIGS. 1 and 2.

As mentioned above, a relative permittivity of the Si conducting layer 16 is 11 to 13, which is much larger than a relative permittivity of 4 to 6 of the SiO₂ buffer layer 14. For example, the Si conducting layer 16 with a thickness of 0.2 μm corresponds to the SiO₂ buffer layer 14 with a thickness of as large as about 0.4 μm to 0.6 μm. As a result, characteristics of the LN optical modulator are highly dependent on the Si conducting layer 16 in reality.

In this embodiment, in addition to all the features described in the first embodiment, the thickness K′ of the Si conducting layer 16 above the side surface of the ridge portion 8a is less than the thickness K of the Si conducting layer 16 above the bottom surfaces 9a, 9b between the ridge portions or above the top parts 10a to 10c of the ridge portions, as can be seen from these figures.

By analogy to FIG. 7, as the thickness K′ of the Si conducting layer 16 above the side surface of the ridge portion 8a shown in FIG. 11 decreases, the electric lines of force generated by the high frequency electric signal cannot easily pass through the Si conducting layer 16 with a high relative permittivity. This results in advantageous effects such as reducing the microwave equivalent refractive index nₘ for the high frequency electric signal, heightening the characteristic impedance Z, and reducing the driving voltage.

Even if the thickness D′ of the SiO₂ buffer layer 14 on the side surface of the ridge portion 8a shown in FIG. 11 is equal to the thickness of the SiO₂ buffer layer 14 on the bottom surface 9b between the ridge portions or on the top part 10a of the ridge portions (that is, D′=D), the advantageous effect of the present invention is realized in part by decreasing the thickness K′ of the Si conducting layer 16 above the side surface of the ridge portion 8a, although the effect is not so obvious compared with that of the invention according to this third embodiment.

The construction disclosed in this application is aimed to optimize (or improve) characteristics of the optical modulator, such as for example, optical modulation bandwidth and driving voltage by making the thickness of the SiO₂ buffer layer 14 or the Si conducting layer 16 formed above the side surface of the ridge portions 8a to 8c less than the thickness of the SiO₂ buffer layer 14 or the Si conducting layer 16 formed above the top parts 10a to 10c of the ridge portions and above the bottom surfaces 9a and 9b between the ridge portions, and by optimizing the structure of the LN optical modulator so as to maximize the optical modulation characteristics, taking into consideration that the electric lines of force 30 pass through the SiO₂ buffer layer 14 or the Si conducting layer 16 above the side surface of the ridge portions 8a to 8c, in response to construction parameters such as thickness T of the traveling wave electrode and width of the center electrode 4a, depth between the top part and the bottom surface of the ridge portions 8a to 8c (that is, the height H of the ridge portions shown in FIG. 11), width of the top parts 10a to 10c of the ridge portions (in particular, the width of the top part 10a above which the center electrode 4a is formed), gap between the center electrode 4a and the ground electrodes 4b, 4c, and inclination of the side surface of the ridge portions 8a to 8c.

Now assume that the optical modulator does not have the SiO₂ buffer layer 14 on the side surface of the ridge portions 8a to 8c. In this case, problems arise in that, for example, the Si conducting layer 16 essential for suppressing the temperature drift is directly deposited onto the side surface of the ridge portions 8a to 8c.

However, since the absorption coefficient of the Si conducting layer 16 is large, the loss of the incident lights respectively traveling through the interaction optical waveguides 3a and 3b becomes large, resulting in a deterioration of important characteristics of the optical modulator, such as for example, insertion loss. Furthermore, since the SiO₂ buffer layer 14 does not cover all the upper surface of the z-cut LN substrate, the distribution of electrical charges due to the pyroelectric effect becomes nonuniform. As a result, it becomes difficult to suppress the temperature drift by the Si conducting layer 16. In other words, the reliability of the optical modulator in terms of the temperature drift becomes degraded. Therefore, it is essential that the SiO₂ buffer layer 14 be formed on the side surface of the ridge portions 8a to 8c in terms of the insertion loss, and that both the SiO₂ buffer layer 14 and the Si conducting layer 16 be formed above the side surface in terms of suppressing the temperature drift.

As mentioned above, it is desirable that the SiO₂ buffer layer 14 and the Si conducting layer 16 are formed above the top parts 10a to 10c of the ridge portions, above the side surface of the ridge portions, and above the bottom surfaces 9a and 9b between the ridge portions. These facts can be applied to all embodiments of this invention. Thus, the embodiment of the present invention is able to maximize the optical modulation characteristics of the LN optical modulator, and to suppress the temperature drift without increasing the insertion loss which is an important characteristic of the optical modulator.

### Fourth Embodiment

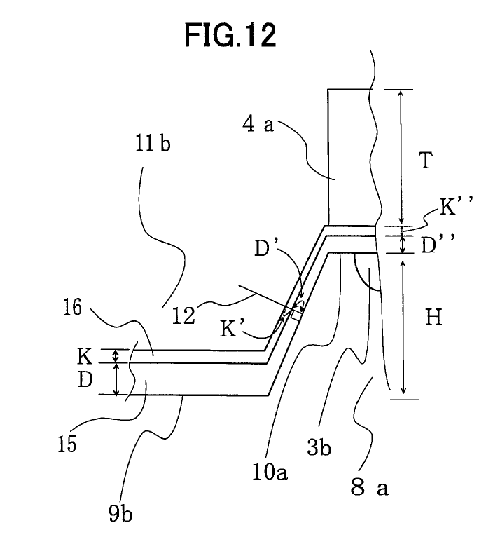

FIG. 12 is a sectional view schematically showing the optical modulator according to the fourth embodiment of the present invention, which is manufactured by controlling the deposition of the SiO₂ buffer layer 15 and the Si conducting layer 16 for suppressing the temperature drift. FIG. 12 is to more fully explain the second embodiment of the present invention shown in FIG. 8, where the explanation of the Si conducting layer 16 for suppressing the temperature drift is not omitted, although the Si conducting layer 16 is omitted only for simplicity in FIG. 8.

In this embodiment, as can be seen from these figures, the thickness of the Si conducting layer 16 above the bottom surface 9b between the ridge portions 8a and 8b is different from the thickness of the Si conducting layer 16 above the top part 10a of the ridge portions. The thickness K′ of the Si conducting layer 16 above the side surface of the ridge portion 8a is less than a larger one of the thickness of the Si conducting layer 16 above the bottom surface 9b between the ridge portions 8a and 8b and the thickness of the Si conducting layer 16 above the top part 10a of the ridge portions.

In the fourth embodiment, as can be seen from FIG. 12, the thickness K of the Si conducting layer 16 above the bottom surface 9b between the ridge portions is larger than the thickness K″ of the Si conducting layer 16 above the top part 10a of the ridge portions. That is to say, K is larger than K″ (K>K″) as shown in FIG. 12. It is also possible that K is less than K″ (K<K″) as long as K′ is less than K″ (K′<K″).

That is to say, it is within the scope of this invention that the thickness K′ of the Si conducting layer 16 above the side surface of the ridge portion 8a is less than a larger one of the thickness of the Si conducting layer 16 above the bottom surface 9b between the ridge portions and the thickness of the SiO₂ buffer layer on the top part 10a of the ridge portions.

Even if the thickness D′ of the SiO₂ buffer layer 15 on the side surface of the ridge portion 8a shown in FIG. 12 is equal to the thickness of the SiO₂ buffer layer 15 on the bottom surface 9b between the ridge portions or on the top part 10a of the ridge portions (that is, D′=D and D′=D″, or D′=D″=D), the advantageous effect of the present invention is realized in part by decreasing the thickness K′ of the Si conducting layer 16 above the side surface of the ridge portion 8a, although the effect is not so obvious compared with that of the invention according to this fourth embodiment.

### Fifth Embodiment

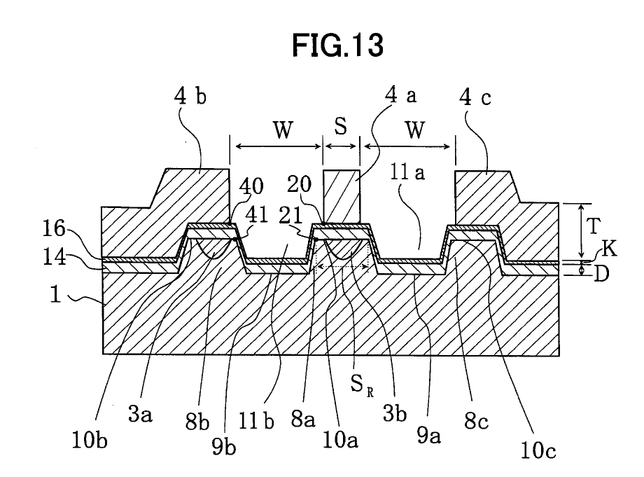

FIG. 13 is a sectional view schematically showing the optical modulator according to the fifth embodiment of the present invention. The legend “S” represents the width of the center electrode 4a, while the legend “S_{R}” represents the width of the top part of the ridge portion 8a. The width S of the center electrode 4a is substantially equal or narrower than the width S_{R} of the top part of the ridge portion 8a. The center electrode 4a has an edge 20 at the lower side thereof. The ridge portion 8a has an edge 21 at the top part thereof. The ground electrode 4b has an edge 40 at the lower side thereof. The ridge portion 8b has an edge 41 at the top part thereof.

If the width S of the center electrode 4a is much smaller than the width S_{R} of the top part of the ridge portion 8a, most of the electric lines of force pass through the z-cut LN substrate 1. This results in the fact that the advantageous effect of the ridge structure and the present invention can not be maximally realized. If the width S of the center electrode 4a is wide enough to be close to the width S_{R} of the top part of the ridge portion 8a, that is, if the edge 20 at the lower side of the center electrode 4a is closer to the edge 21 at the top part of the ridge portion 8a in a horizontal direction, the advantageous effect of the ridge structure becomes obvious. Therefore, if the thickness of the SiO₂ buffer layer 14 or the Si conducting layer 16 deposited on the side surface of the ridge portion 8a, is too large, many electric lines of force tend to pass through the SiO₂ buffer layer 14 and the Si conducting layer 16. This results in the optical modulation characteristics of the LN optical modulator being deteriorated. The advantageous effect of the present invention, however, is obvious, since the thickness of the SiO₂ buffer layer 14 or the Si conducting layer 16 deposited on the side surface of the ridge portion 8a is relatively small. Here, the ratio of the width S of the center electrode 4a divided by the width S_{R} of the top part of the ridge portion 8a is preferably in the range of approximately 0.2 to 1. The same thing is true of the ground electrodes 4b, 4c. The advantageous effect of the present invention is also obvious in such case where the edge 40 at the lower side of the ground electrode 4b is closer to the edge 41 at the top part of the ridge portion 8b in a horizontal direction.

### Sixth Embodiment

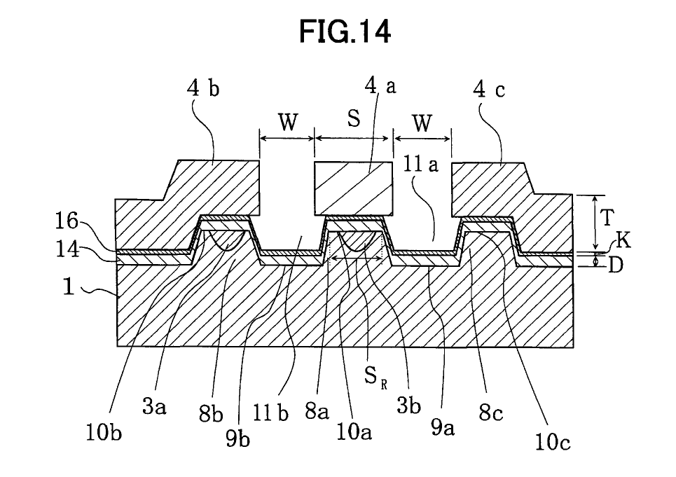

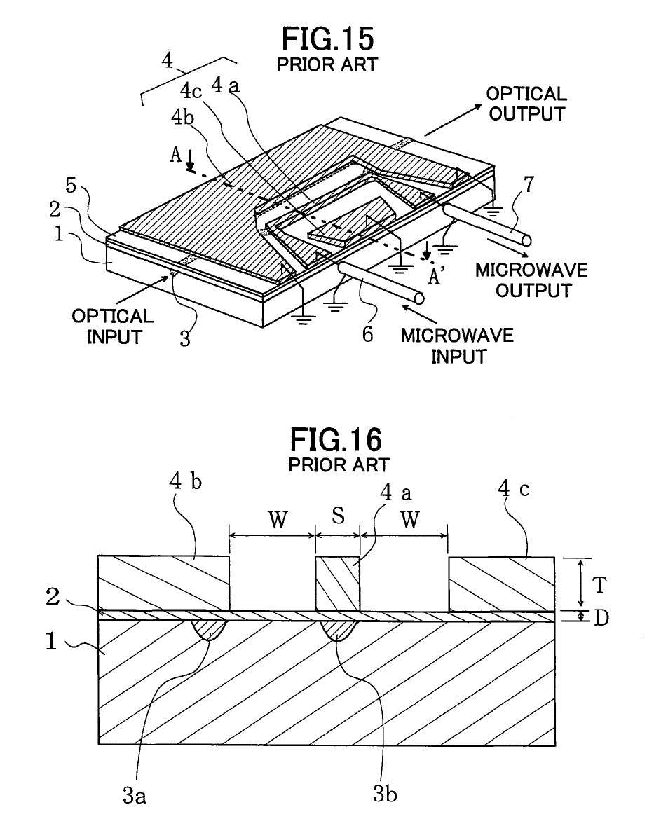

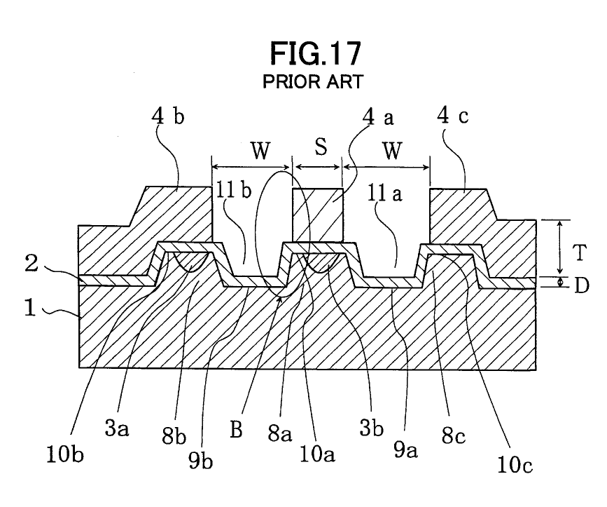

FIG. 14 is a sectional view schematically showing the optical modulator according to the sixth embodiment of the present invention. The legend “S” represents the width of the center electrode 4a, while the legend “S_{R}” represents the width of the top part of the ridge portion 8a. The width S of the center electrode 4a is substantially larger than the width S_{R} of the top part of the ridge portion 8a. If the width S of the center electrode 4a is much wider than the width S_{R} of the top part of the ridge portion 8a, the advantageous effect of the present invention, that is, reducing the length of the electric lines of force entering or passing through the SiO₂ buffer layer 14 or the Si conducting layer 16 above the side surface of the ridge portions 8a to 8c, is not so obvious. This leads to the fact that the ratio of the width S of the center electrode 4a divided by the width S_{R} of the top part of the ridge portion 8a is preferably less than 5, thereby effectively providing the advantageous effect of the ridge structure and the present invention.

### Each Embodiment

As mentioned above, the fact that the SiO₂ buffer layer or the Si conducting layer above the side surface of the ridge portions seriously affects the optical modulation characteristics, such as optical modulation bandwidth, driving voltage, jitter in optical pulses, and characteristic impedance, is ignored to construct the conventional optical modulator. Therefore, the above mentioned optical modulation characteristics are deteriorated in the case where the thickness of the SiO₂ buffer layer or the Si conducting layer above the side surface of the ridge portions is too large, or in the case where the SiO₂ buffer layer or the Si conducting layer is not formed above the side surface of the ridge portions. The present invention, however, is aimed to optimize (or improve) the optical modulation characteristics by optimizing the structure of the LN optical modulator, by depositing the SiO₂ buffer layer and the Si conducting layer above the side surface of the ridge portions, by making the thickness of the SiO₂ buffer layer and the Si conducting layer above the side surface of the ridge portions less than the thickness of the SiO₂ buffer layer and the Si conducting layer above the top part of the ridge portions or the bottom surface between the ridge portions, and by taking into consideration that the electric lines of force pass through the SiO₂ buffer layer and the Si conducting layer. Furthermore, since the SiO₂ buffer layer is formed on the side surface of the ridge portions, the insertion loss does not increase, and the characteristic of the temperature drift does not deteriorate.

Although there has been described about the fact that the Mach-Zehnder optical waveguide exemplifies the branch-type optical waveguide, it goes without saying that the principle of this invention can be applied to any optical waveguides having a bifurcation portion and a mix portion exemplified by an optical directional coupler. In addition, the principle of this invention can be applied to the optical waveguide constituted by more than two interaction optical waveguides, and can also be applied to the phase modulator having one optical waveguide. The optical waveguide may be formed with any methods exemplified by a proton exchange method instead of the method of titanium thermal diffusion. In a similar manner, the buffer layer may be made of any materials such as Al₂O₃ instead of the SiO₂. Furthermore, although there has been described that the Si conducting layer functions as a conducting layer, the conducting layer may be a layer (or film) with appropriate electrical resistance. Therefore, it goes without saying that the conducting layer may consist of other materials.

Although there has been described about the fact that the LN substrate has a z-cut state, the LN substrate may have another cut state. The LN substrate may be replaced by other substrate such as a lithium tantalite substrate and a semiconductor substrate. Although there has been described about the fact that the Si conducting layer is formed “over” the SiO₂ buffer layer, other layers may intervene between the Si conducting layer and the SiO₂ buffer layer.

Although there has been described about the fact that the LN substrate has three ridge portions, the LN substrate may have one or two ridge portions, or other number of ridge portions. Furthermore, the ridge portions may have height different from each other. In the embodiments of this invention, the word “ridge portion” is used in a broad sense. Therefore, the z-cut LN substrate may be dug only “9a” and “9b” in FIGS. 7 to 14, and not dug at any other portions including the portions below the ground electrodes 4b, 4c.

In the embodiments of this invention, the description “decreasing the thickness of the SiO₂ buffer layer or the Si conducting layer above the side surface of the ridge portions” means that at least a part of the thickness of the SiO₂ buffer layer or the Si conducting layer above the side surface of the ridge portions is less than the greatest thickness of the SiO₂ buffer layer or the Si conducting layer above the side surface of the ridge portions. The present invention is aimed to maximize (or improve) the optical modulation characteristics, by optimizing the structure of the LN optical modulator, such as thickness and width of the traveling wave electrode, width and height of the ridge portions, thickness of the SiO₂ buffer layer or the Si conducting layer above the bottom surface between the ridge portions or above the top part of the ridge portions.

The buffer layer on the side surface of the ridge portions may be completely removed by wet etching or thy etching, after patterning a photoresist on the surface of the ridge portions except the side surface. In this case, the optimum height of the ridge portions is less than that in the case where the buffer layer is formed on the side surface of the ridge portions.

In all embodiments of this invention, the SiO₂ buffer layer and the Si conducting layer are fabricated by various methods such as sputtering and electron beam evaporation. These layers deposited above the side surface of the ridge portions have thickness different from each other according to fabricating methods. Therefore, the advantageous effect of the LN optical modulator can be sufficiently realized by designing the structure such as the thickness of these layers above the side surface of the ridge portions according to the principle of this invention.

Although there has been described about the fact that the electrode is constituted by the CPW having a symmetric structure, the electrode may be formed by a CPW having an asymmetric structure, an asymmetric coplanar strip (ACPS), symmetric coplanar strip (CPS) or the like. Part of the center electrode and the ground electrode forming the traveling wave electrode may directly contact with the LN substrate.

In general, the interaction optical waveguide 3b below the center electrode 4a is positioned so that the interaction optical waveguide 3b is positioned right below the center electrode 4a. That is, the center axis, extending in a propagation direction, of the interaction optical waveguide 3b is parallel in a vertical plane to the center axis, extending in a propagation direction, of the center electrode 4a, to ensure that the optical modulation efficiency becomes highest. However, the interaction optical waveguide 3b may be positioned below the side edge of the center electrode 4a under the condition that the center electrode 4a has a large width.

In addition, it goes without saying that the output portion for outputting the electric signal may be terminated with a terminator having impedance such as 40Ω and 50Ω Although there has been assumed that the characteristic impedance of the external circuit is 50Ω, it is within the scope of this invention that the external circuit or the optical modulator may have characteristic impedance not close to 50Ω as long as the characteristic impedance can be heightened by making the thickness of at least a part of the buffer layer formed on the side surface of the ridge portions less than the thickness of the buffer layer on the bottom surface between the ridge portions or on the top part of the ridge portions, or, in the extreme case, by not forming the buffer layer on a part or whole of the side surface of the ridge portions.

In accordance with the present invention, there is provided an optical modulator which can have a wide optical modulation bandwidth due to the fact that the microwave equivalent refractive index nₘ can effectively be shifted closer to the effective refractive index n₀ of the interaction optical waveguides, while reducing the driving voltage, and improving the value of characteristic impedance and process yield, by making the thickness of the SiO₂ buffer layer (or the Si conducting layer) above the side surface of the ridge portions less than the thickness of the SiO₂ buffer layer (or the Si conducting layer) above the bottom surface between the ridge portions and/or the thickness of the SiO₂ buffer layer (or the Si conducting layer) above the top part of the ridge portions, and by optimizing the structure.

1. An optical modulator, comprising:
a substrate having an electro-optic effect;
a buffer layer formed over said substrate;
a conducting layer formed over said buffer layer; and
a traveling wave electrode including a center electrode and a ground electrode formed on at least a part of said conducting layer, in which
said substrate has a plurality of ridge portions which are formed by digging said substrate at regions where electric field generated by a high frequency electric signal traveling through said traveling wave electrode is strong, and
at least one of said ridge portions has an optical waveguide formed therein, characterized in that
said buffer layer is formed on a top part and a side surface of said ridge portions, and on a bottom surface between said ridge portions formed by said digging, and
a thickness of said buffer layer along a normal line of said side surface of said ridge portions is less than a thickness of said buffer layer on said bottom surface between said ridge portions and/or a thickness of said buffer layer on said top part of said ridge portions, to ensure that a microwave equivalent refractive index for said high frequency electric signal is reduced to be closer to an effective refractive index of said optical waveguide, as compared to the case where a thickness of said buffer layer along a normal line of said side surface of said ridge portions is equal to a larger one of a thickness of said buffer layer on said top part of said ridge portions and a thickness of said buffer layer on said bottom surface between said ridge portions.

2. An optical modulator as set forth in claim 1, in which said side surface of said ridge portions is inclined.

3. An optical modulator as set forth in claim 1, in which
a thickness of said buffer layer along a normal line of said side surface of said ridge portions is less than ¾ of a thickness of said buffer layer on said bottom surface between said ridge portions formed by said digging and/or a thickness of said buffer layer on said top part of said ridge portions.

4. An optical modulator as set forth in claim 1, in which
a thickness of said buffer layer along a normal line of said side surface of said ridge portions is less than ⅔ of a thickness of said buffer layer on said bottom surface between said ridge portions formed by said digging and/or a thickness of said buffer layer on said top part of said ridge portions.

5. An optical modulator as set forth in claim 1, in which
a thickness of said buffer layer along a normal line of said side surface of said ridge portions is less than ½ of a thickness of said buffer layer on said bottom surface between said ridge portions formed by said digging and/or a thickness of said buffer layer on said top part of said ridge portions.

6. An optical modulator as set forth in claim 1, in which
said conducting layer is formed above said top part and said side surface of said ridge portions, and above said bottom surface between said ridge portions formed by said digging, and
a thickness of said conducting layer along a normal line of said side surface of said ridge portions is less than a thickness of said buffer layer on said bottom surface between said ridge portions and/or a thickness of said conducting layer above said top part of said ridge portions, to ensure that a microwave equivalent refractive index for said high frequency electric signal is reduced to be closer to an effective refractive index of said optical waveguide, as compared to the case where a thickness of said conducting layer along a normal line of said side surface of said ridge portions is equal to a larger one of a thickness of said conducting layer above said top part of said ridge portions and a thickness of said conducting layer above said bottom surface between said ridge portions.

7. An optical modulator as set forth in claim 6, in which
a thickness of said conducting layer along a normal line of said side surface of said ridge portions is less than ¾ of a thickness of said conducting layer above said bottom surface between said ridge portions formed by said digging and/or a thickness of said conducting layer above said top part of said ridge portions.

8. An optical modulator as set forth in claim 6, in which
a thickness of said conducting layer along a normal line of said side surface of said ridge portions is less than ⅔ of a thickness of said conducting layer above said bottom surface between said ridge portions formed by said digging and/or a thickness of said conducting layer above said top part of said ridge portions.

9. An optical modulator as set forth in claim 6, in which
a thickness of said conducting layer along a normal line of said side surface of said ridge portions is less than ½ of a thickness of said conducting layer above said bottom surface between said ridge portions formed by said digging and/or a thickness of said conducting layer above said top part of said ridge portions.

10. An optical modulator as set forth in claim 1, in which
a width of said top part of one of said ridge portions which has said optical waveguide formed therein and around which said center electrode of said traveling wave electrode is formed is substantially equal to a width of said center electrode.

11. An optical modulator as set forth in claim 1, in which
a width of said top part of one of said ridge portions which has said optical waveguide formed therein and around which said center electrode of said traveling wave electrode is formed is wider than a width of said center electrode.

12. An optical modulator as set forth in claim 1, in which
a width of said top part of one of said ridge portions which has said optical waveguide formed therein and around which said center electrode of said traveling wave electrode is formed is narrower than a width of said center electrode.

13. An optical modulator as set forth in claim 1, in which
a ratio of said width of said center electrode divided by said width of said top part of one of said ridge portions is in the range of ⅕ to 1.

14. An optical modulator as set forth in claim 1, in which
a ratio of said width of said center electrode divided by said width of said top part of one of said ridge portions is in the range of 1 to 5.

15. An optical modulator as set forth in claim 1, in which
said optical waveguide formed in at least one of said ridge portions is positioned right below said center electrode of said traveling wave electrode, with said buffer layer intervening between said optical waveguide and said traveling wave electrode.
